(19) United States
(12) Patent Application Publication
(10) Pub. No.: US 2023/0209621 A1
(43) Pub. Date: Jun. 29, 2023

(54) METHODS, ARCHITECTURES, APPARATUSES AND SYSTEMS FOR DISCOVERY, SELECTION AND OPTIMAL ACCESS TO EDGE COMPUTING NETWORKS

(71) Applicant: InterDigital Patent Holdings, Inc., Wilmington, DE (US)

(72) Inventors: Ulises Olvera-Hernandez, Saint-Lazare (CA); Xiaoyan Shi, Westmount (CA); Saad Ahmad, Montréal (CA); Michelle Perras, Montréal (CA)

(21) Appl. No.: 17/925,713

(22) PCT Filed: May 20, 2021
(86) PCT No.: PCT/US2021/033288

§ 371 Date: Nov. 16, 2022

Related U.S. Application Data
(60) Provisional application No. 63/028,260, filed on May 21, 2020.

(51) Int. Cl. H04W 76/12; H04W 76/22

(52) U.S. Cl. CPC H04W 76/12; H04W 76/22

(57) ABSTRACT

Procedures, methods, architectures, apparatuses, systems, devices, and computer program products are described herein for discovery, selection and optimal access to edge computing networks. A WTRU may identify relevant application servers, for example, based on application level procedures. A WTRU may derive a mapping, for example, from selected applications and an application function (AF) transaction ID. A WTRU may request access to an edge application server (EAS), for example, via a packet data unit PDU) session establishment or a PDU session modification procedure, e.g., based on an AF transaction ID. A WTRU may obtain a new EAS address, for example, based on receipt of a PDU session establishment and/or a modification accept message.

### CROSS-REFERENCE TO RELATED APPLICATIONS

This application claims the benefit of U.S. Provisional Patent Application No. 63/028,260 filed 21 May 2020 which is incorporated herein by reference.

### BACKGROUND

The present disclosure is generally directed to the fields of communications, software and encoding, including, for example, to methods, architectures, apparatuses, systems directed to mobile communications using wireless communication. Mobile communications using wireless communications continue to evolve. A fifth generation may be referred to as 5G. A previous (legacy) generation of mobile communication may be, for example, fourth generation (4G) long term evolution (LTE).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of mapping edge application server (EAS) regions to a protocol data unit (PDU) session anchors (PSA) through one or more data network access identifiers (DNAIs);

FIG. 3 is a diagram illustrating an example of application function (AF) influence on user traffic;

FIG. 4 is a diagram illustrating an example of establishing PDU sessions on one or more additional/newly established PSAs;

FIG. 5 is a diagram illustrating an example of an application layer architecture supporting edge computing services;

FIG. 6 is a diagram illustrating a representative example of a service provisioning procedure prior to PSA and/or EAS relocation;

FIG. 7 is a diagram illustrating a representative example of an application server discovery procedure;

FIG. 8 is a diagram illustrating a representative example of a combined application level and system level EAS and/or PSA relocation procedure;

FIG. 9 is a diagram illustrating a representative example of a PDU session establishment procedure;

FIG. 10 is a diagram illustrating another representative example of a PDU session establishment procedure;

FIG. 11 is a diagram illustrating another representative example of a PDU session establishment procedure; and

FIG. 12 is a diagram illustrating another representative example of a PDU session establishment procedure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof

### Example Communications System

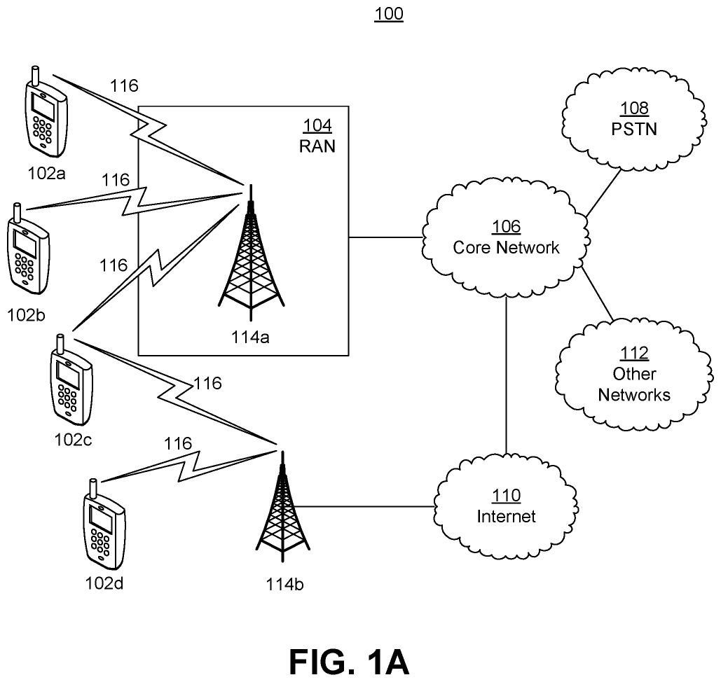

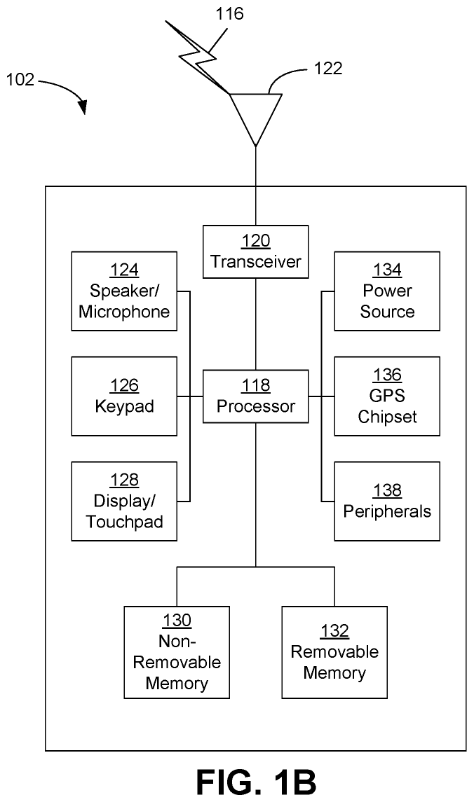

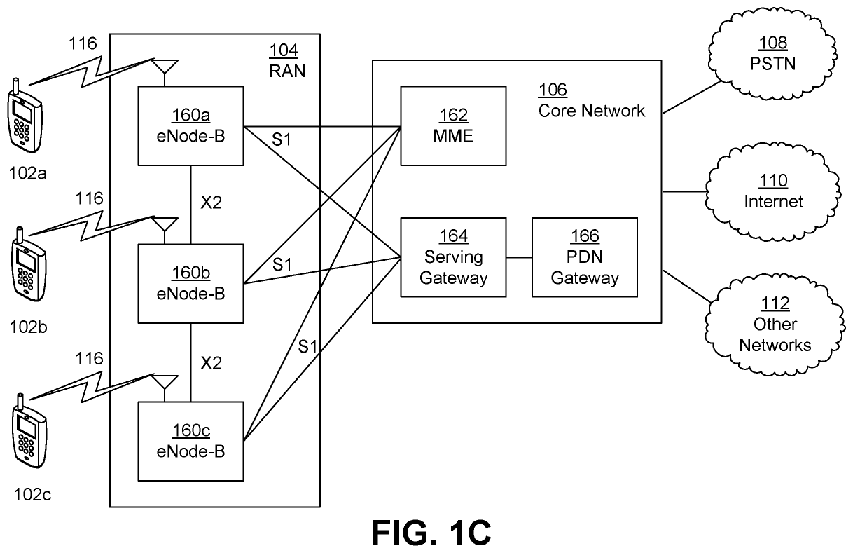

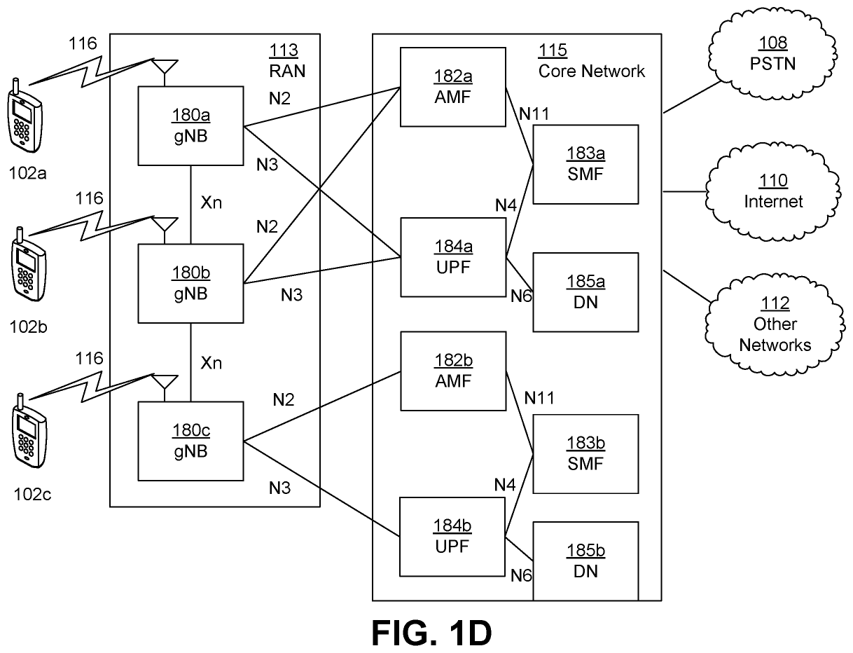

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1x, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In anon-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Relocation handling may be provided for a packet data unit (PDU) session anchor (PSA) and an edge application server (EAS).

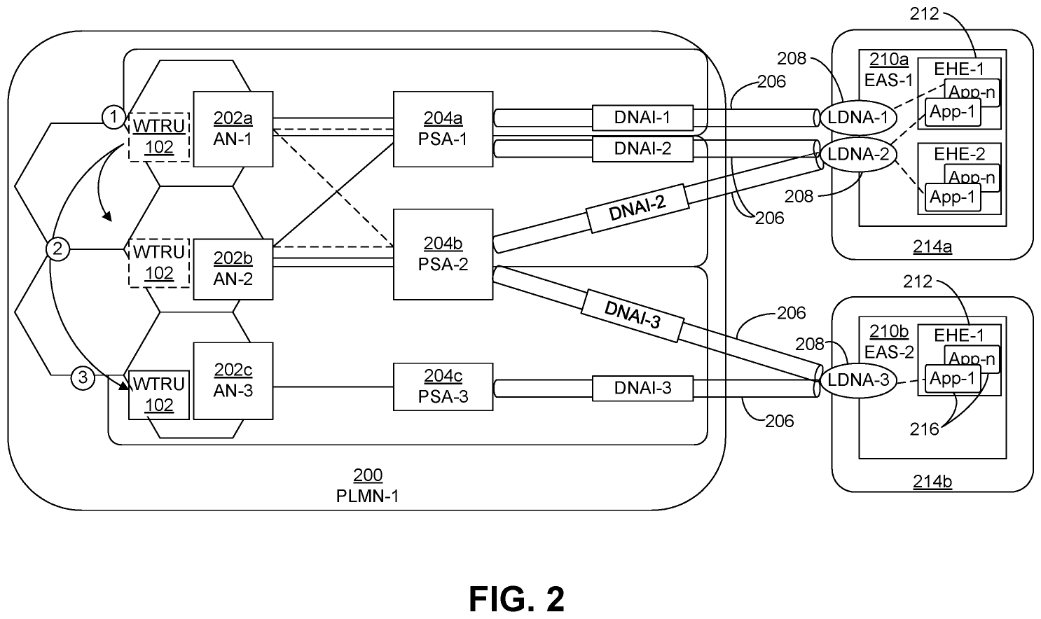

FIG. 2 is a diagram illustrating an example of mapping edge application server (EAS) regions to a packet data unit (PDU) session anchors (PSAs) through one or more data network access identifiers (DNAIs). As shown in FIG. 2, a DNAI may be used at a user plane function (UPF) (e.g., based on traffic routing policies) to route packets to application function (AF) regions where edge application servers (EASs) may be located.

As shown in FIG. 2, a PLMN-1 200 may include plural access networks 202a, 202b, and 202c. The access networks 202a, 202b and 202c may be logically associated multiple PSAs 204a, 204b and 204c. A first PSA 204a “PSA-1” may provide access to a first local data network access “LDNA-1” 208 using a first DNAI “DNAI-1” and a respective N-6 tunnel 206. The first PSA 204a may also provide access to a second local data network access “LDNA-2” 208 using a second DNAI “DNAI-1” and a respective N-6 tunnel 206. A second PSA 204b “PSA-2” may provide access to the second local data network access “LDNA-2” 208 using the second DNAI “DNAI-2” and a respective N-6 tunnel 206. The second PSA 204b “PSA-2” may provide access to a third local data network access “LDNA-3” 208 using a third DNAI “DNAI-3” and a respective N-6 tunnel 206. A third PSA 204c “PSA-3” may provide access to a third local data network access “LDNA-3” 208 using the third DNAI “DNAI-3” and a respective N-6 tunnel 206. As shown in FIG. 2, a first data network 214a may be accessible using LDNA-1 and/or LDNA-2 (e.g., via PSA-1 and/or PSA-2). A second data network 214b may be accessible using LDNA-3 (e.g., via PSA-2 and/or PSA-3). The first data network 214a may include a first EAS “EAS-1” 210a and the second data network may include a second EAS “EAS-2” 210b. A third data network 214c may include a third EAS “EAS-3” 210c. The first EAS 210a may be configured with one or more edge hosting environments (EHE) 212 such as EHE-1 and/or EHE-2. For example, one or more applications (e.g., App-1 to App-n) may be executed on the EHE-1 212 and one or more applications (e.g., App-1 to App-n) may be executed on the EHE-2 212. EASs 210b and 210c may be similarly configured.

In an example, a PSA (e.g., PSA-1 204a) may route WTRU traffic using traffic steering policies associated with a DNAI (e.g., DNAI-2) to send application data destined for an application (e.g., App-1) toward a DN (e.g., DN 214a) as illustrated in FIG. 2 at step 1. At step 2, a WTRU 102 may move from a first access network (e.g., from the AN-1 202a) to a second access network (e.g., to the AN-2 202b) which may have access to PSA-1. AN-2 may be within an area of validity of PSA-1 serving the first data network 214a. Packets may (e.g., continue) to be routed using DNAI-2, for example, without re-allocating a new PSA. Service and session continuity may (e.g., therefore) be maintained. At step 3, the WTRU 102 may move (e.g., from the AN-2 202b) to another access network (e.g., the AN-3 202c). The AN-3 202c may be outside the service area of DN 214a, which may cause PSA relocation, for example, to steer traffic towards a (e.g., new) EAS (e.g., EAS-2 210b). PSA-3 may (e.g., as illustrated by example in FIG. 2) use a different DNAI (e.g., DNAI-3), for example, to reach the LDNA-3 208. For example, App-1 may be available in the region of LDNA-3.

Edge application server (EAS) availability may be provided.

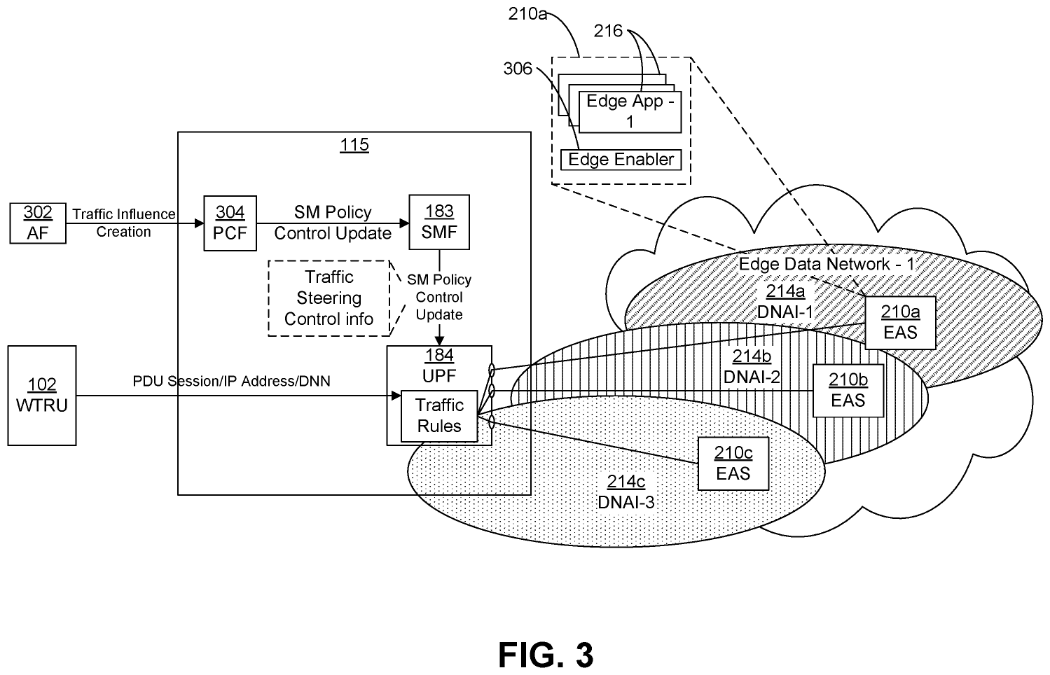

FIG. 3 is a diagram illustrating an example of application function (AF) 302 influence on user traffic. As shown in FIG. 3, one or more AFs 302 may influence traffic towards one or more EASs 210 in a 5G system (5GS), such as a core network 115. For example, AFs 302 may (e.g., be used to) influence traffic towards one or more EASs 210a, 201b, 210c that may be used for edge computing. Traffic steering towards specific EASs among ASs may be desirable. An AS (e.g., an EAS) may provide advantages, such as close proximity to a user accessing application that may be hosted in the AS and/or providing relief for congested servers. An EAS, such as EAS 210a, may be configured with one or more edge applications (e.g., app-1 to app-n as in FIG. 2) and an edge enabler 306.

AFs 302 may enable traffic steering towards one or more EASs 210. User traffic may be routed to EASs 210 in a system, such as a 5GS (e.g., by a SMF 183 and/or a UPF 184), using, for example, one or more traffic filters. A traffic filter may be in the form of, for example, one or more routing profiles or traffic routing information associated with access to a data network location. A data network location may be identified by a DNAI, e.g., DNAI-1,2,3 as depicted in FIGS. 2 and 3.

One or more traffic filters (e.g., traffic rules) may be installed in one or more (e.g., selected) UPFs, such as a UPF 184 handling a PDU session. A UPF 184 may (e.g., based on one or more traffic filters) route user traffic to a DNAI, which may be associated with a data network name (DNN), a single network slice selection assistance information (S-NSSAI), or a PDU Session. A DNAI may (e.g., as shown in FIG. 3) represent access to a data network, such as an edge data network, where applications (e.g., relevant to the traffic being routed) may be located.

A UPF 184 may perform packet marking, for example, to indicate a (e.g., certain) type of traffic to the DN side of the N6 reference point, which may enable the (e.g., marked) packets to be steered in the DN. A UPF 184 may forward (e.g., offload) traffic (e.g., identified by a traffic descriptor) to a local tunnel.

Traffic filters (e.g., and a traffic steering configuration provided by an AF 302) may be specific to a UPF 184 anchoring a PDU Session (e.g., a PSA). A WTRU may move away from a service area associated with a (e.g., current) PSA 204. A PSA 204 serving a PDU session (e.g., associated with a particular application) may be relocated (e.g., as shown in step 3 in FIG. 2).

A reactive approach may be used to relocate a PSA 204. For example, an AF 302 (e.g., as shown in FIG. 3) may subscribe to events in a system (e.g., a 5GS), such as mobility or DNAI change. An AF 302 may provide a new configuration, for example, based on the occurrence of an event (e.g., a mobility or DNAI change). A new configuration may allow the system to update traffic steering rules, for example, to reestablish communications between the client and an EAS 210 running a relevant application 216.

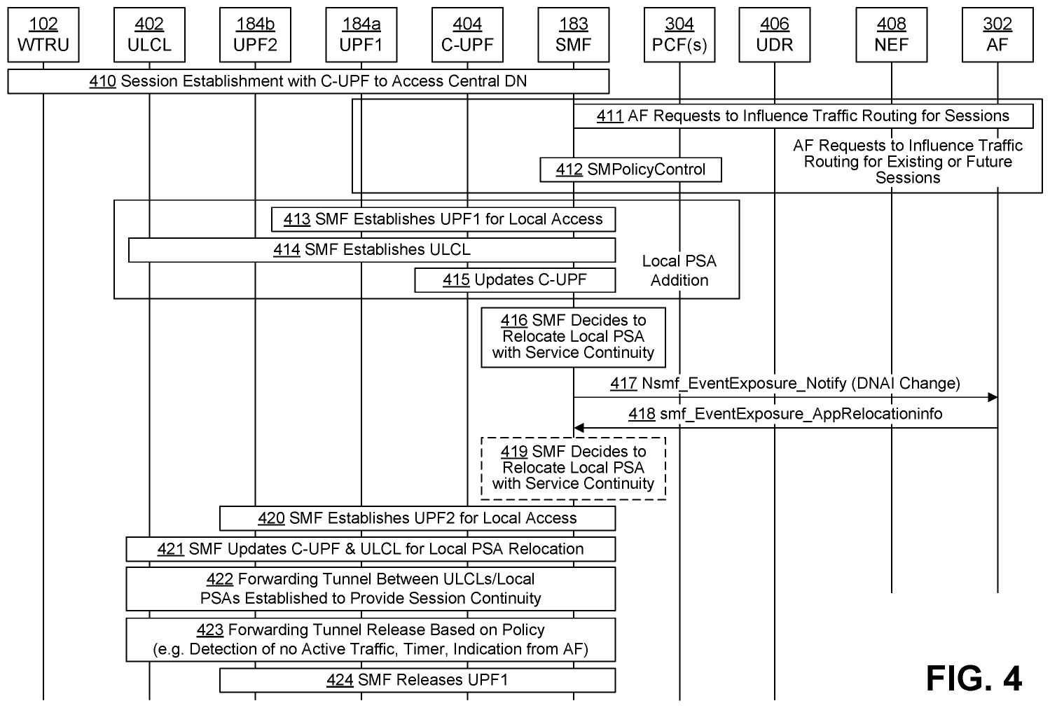

FIG. 4 is a diagram illustrating an example of establishing PDU sessions on one or more additional/newly established PDU session anchors (PSAs) 204. There may be an assumption that (e.g., at some point) traffic may be steered toward the additional/newly established PSA(s). The system may determine when traffic should be switched to an additional/newly established PSA. FIG. 4 shows a DNAI change for an additional/newly established PSA 204 for a PDU session using an uplink classifier (ULCL) 402.

As shown in FIG. 4, at 410, the WTRU 102 may perform session establishment with a C-UPF 404 to access a central DN. At 411, the AF 302 may send a request to influence traffic routing for the session, and a related SM policy is updated to the SMF 183 at 412.

At 413 to 415, based on the network environment and policy, the SMF 183 may decide that some selective traffic should route to the DN via a local PSA 204. For example, a new local data plane path may be established with UPF1 184a.

At 416, upon WTRU 102 mobility or load balancing, the SMF 183 may decide to relocate the local PSA 204. For example, if service continuity for local offload traffic is indicated, the SMF 183 may also decide whether the local PSA 204 is relocated with service continuity or not.

At 417, the SMF 183 may report the DNAI change to the AF 302, and the AF 302 may acknowledge the report with related information at 418.

At 419, the SMF 183 may decides whether to support service continuity or not while relocating the local PSA. The SMF 183 may establish the UPF2 184b for local access and may update the ULCL 402. If the ULCL 402 is relocated, the C-UPF 404 may also be updated. If service continuity is supported for the local PSA relocation, steps 422 to 423 may be executed, otherwise, steps 422 to 423 may be skipped.

At 422 and 423, if the ULCL 402 is relocated, a forwarding tunnel between the source ULCL and target ULCL can be used to support session continuity. For example, if the ULCL 402 supports reordering function, in order to assist the reordering function in the ULCL/Target ULCL, the source PSA may send one or more “end marker” packets. The forwarding tunnel release, based on policy, may be decided based on the detection of no active traffic, a configured timer or an indication from an AF 302. No signal interaction with the WTRU 102 is needed as the local PSA while using the ULCL 402 is unseen to the WTRU 102.

At 424, the SMF 183 may proceed to release the UPF1 184a.

Edge computing services may be enhanced, for example, at a system level and/or an application level (e.g., EAS discovery, selection and reselection).

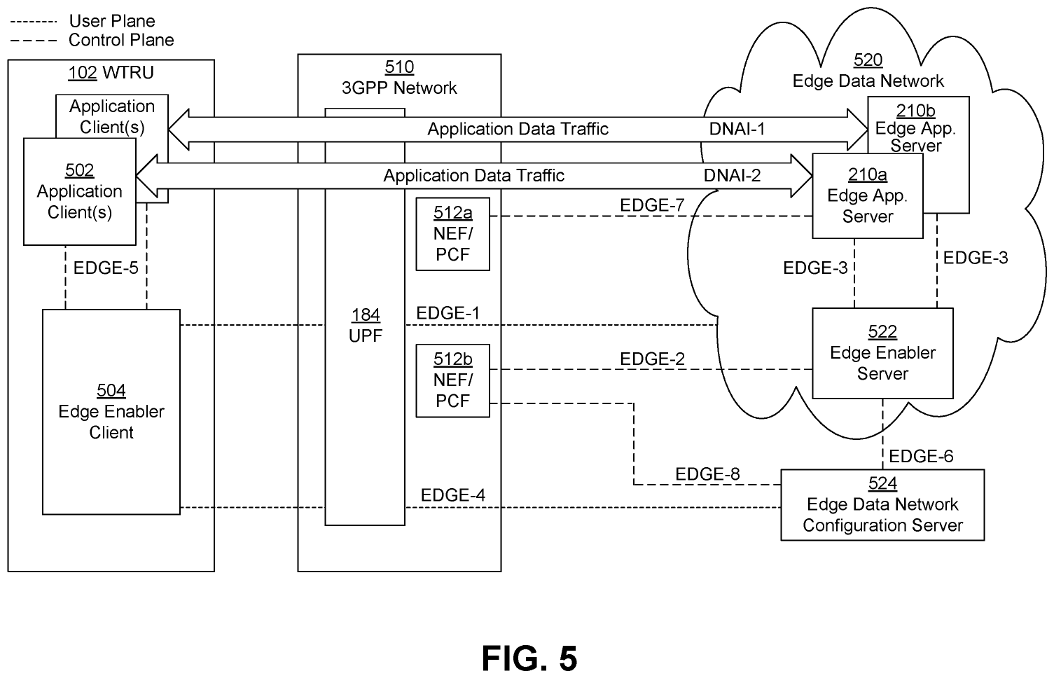

FIG. 5 is a diagram illustrating an example of an application layer architecture supporting edge computing services. Application layer components and interfaces are shown in the context of system architecture components.

In FIG. 5, a WTRU 102 may include (e.g., execute) one or more application clients 502 and an edge enabler client (EEC) 504. An application client 502 may be application software resident in the WTRU 102 and may perform a client function (e.g., with respect to an EAS performing a server function). An EEC 504 may be functional entity resident in the WTRU 102 providing services for any application clients 504. The WTRU 102 may be connected via a 3GPP network 510 to an edge data network 520. The 3GPP network 510 may include a UPF 184, a NEF and/or PCF 512a which is associated with one or more of the EASs 210a, 210b, and a NEF and/or PCF 512b which is associated with an edge enabler server (EES) 522. The EES may be a functional entity resident in an EHE providing services for EASs 210 and EECs 504. The EHE may be an environment providing the support required for EAS 210 execution. An edge data network configuration server (ECS) 524 may provide support for a WTRU 102 to connect with an EES 522.

For example, the EES 522 may provide supporting functions needed for EASs to run in an Edge Data Network 520. The EES 522 may provision configuration information to enable the exchange of Application Data Traffic with an EAS 210, and provide information related to the EAS 210, such as availability, to the EEC 504.

For example, the EEC 504 may provide supporting functions needed for the application client(s) 502. The EEC 504 may perform retrieval and provisioning of configuration information to enable the exchange of Application Data Traffic with an EAS 210. The EEC 504 may also perform discovery of EASs 210 available in the edge data network 520.

For example, the ECS 524 may provide supporting functions needed for the WTRU 102 to connect with an EES 522. The ECS 524 may perform provisioning of edge data network 520 configuration information to an EEC 504. The network configuration information may include any of information for a WTRU 102 to connect to the edge data network 520 with its service area information and/or information for establishing a connection with an EES 522 (e.g., such as a URI).

FIG. 5 shows “Application Data Traffic”, “EDGE 1” and “EDGE 4” reference points that may be carried as user plane traffic, which may be carried over a PDU session supported through a UPF. “EDGE 2,” “EDGE 7” and “EDGE 8” reference points may be (e.g., defined as) application programming interfaces (APIs), for example, for retrieval of network capability information, and/or may be (e.g., defined as) control plane interfaces that may use service based operation (e.g., using relevant APIs). “EDGE 3” reference points are between the EES 522 and the EASs 210. The “EDGE 6” reference point is between the EES 522 and the ECS 524. The “EDGE 7” reference point is between the NEF/PCF 512a and the EASs 210. The “EDGE 7” reference point may support access to 3GPP Network functions and APIs for retrieval of network capability information, e.g. via SCEF and NEF APIs. The “EDGE 8” reference point is between the NEF/PCF 512b and the ECS 524. The “EDGE 8” reference point may support Edge Data Network configurations provisioning to the 3GPP network utilizing network exposure services.

Re-allocation of PSAs and/or EAS relocation may be handled (e.g., reactively), for example, based on 5GS notification towards the AF. Events identified by a system (e.g., a 5GS), for example, with notification being provided to the AF, may (e.g., be assumed to) trigger the steering of application data traffic from one or more currently established PDU sessions toward one or more newly established PSAs, which may provide one or more advantages over the current PDU Session. A system (e.g., a 5GS) may determine if (e.g., and when) traffic should be switched to the newly established/additional PSAs.

Reactive notifications may be provided for (e.g., specific) event(s) configured by an AF. A system (e.g., a 5GS) may (e.g., when one or more events occur) notify an AF, which may (e.g., in turn) react with a new configuration request towards the system (e.g., the 5GS), for example, as illustrated in FIG. 4, step 8. One or more events (e.g., mobility events) may not require a change of PSA (e.g., as illustrated in FIG. 2, Step 2). Reactive configuration requests to mobility event notifications may result in unnecessary/unwanted PSA re-allocations. A PSA reallocation procedure (e.g., whether warranted or unwarranted) may trigger a series of events with external entities, which may cause delays. Data may be buffered during delays. A quick re-location of a PSA (e.g., just in time or right at the time the application requires the change) may be implemented, for example, without unnecessary/unwanted PSA re-allocations and/or without or with reduced delays.

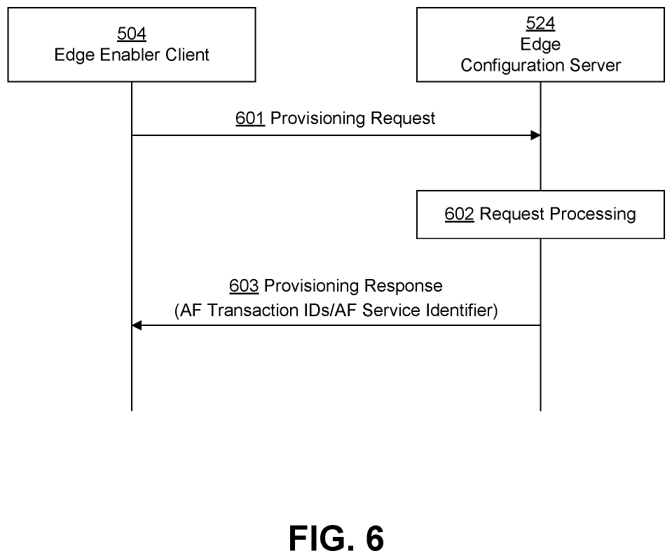

Application level enhancements may be provided. EAS information may be provisioned, for example, prior to PSA change, and/or EAS relocation. A WTRU 102 (e.g., that has established a connectivity with an ECS 524) may (e.g., at any point in time) retrieve edge data network information, such as, for example, one or more of the following: a DNN, a uniform resource identifier (URI), a cell/tracking area (TA) list, public land mobile network (PLMN) IDs, a local DN service area (e.g., if the DNN is a local area data network (LADN)), AF transaction IDs, and/or an AF Service identifier (e.g., if available). A WTRU may correlate two or more (e.g., of these) parameters, for example, to identify DNNs and/or (e.g., certain) spatial information, such as, for example, the parameters provided (e.g., DNN, URI, Cell/TA or DN Service Area). FIG. 6 illustrates an example.

FIG. 6 is a diagram illustrating an example of service provisioning prior to PSA reallocation and/or EAS relocation. At 601, the WTRU 102 (e.g., via the EEC 504) may send a provisioning request to an ECS 524. The ECS 524 may process the received provisioning request at 602. After 602, the ECS 524 may send edge data network information as a provisioning response to the WTRU 102 (e.g., via the EEC 504) that is responsive to the provisioning request at 603. The edge data network information may include one or more AF transaction IDs and/or AF service IDs.

EAS discovery information may be requested and/or provided, for example, prior to PSA change and/or EAS relocation. A WTRU 102 may be mobile (e.g., capable of moving through) a system, such as a SGS. One or more events may trigger (e.g., a need for) a WTRU to contact an (e.g., a specific) EAS 210. For example, a WTRU may move away from one or more service areas obtained during an initial provisioning (e.g., as described herein), which may trigger an (e.g., a new) EA discovery procedure (e.g., as illustrated by in FIG. 1 at 701).

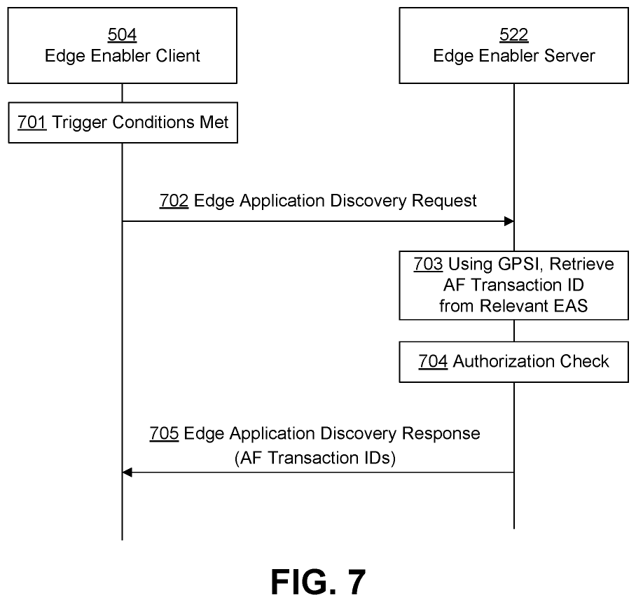

FIG. 7 is a diagram illustrating an example of an application server discovery procedure. As shown for example in FIG. 7, one or more events may trigger an EA discovery procedure at 701. At 702, an EEC 503 may send an edge application discovery request to an EES 522, for example, based on the one or more trigger conditions being met at 701. At 703, the EES 522 may retrieve one or more AF transaction IDs (e.g., from any EASs 210 that may be associated with the EEC 503). For example, AF transaction IDs may be retrieved based on a generic public subscription identifier (GPSI) associated with the EEC 504. At 704, the EES 522 may perform an authorization check for the EEC 504. At 705, the EES 522 may provide an edge application discovery response, which may include the AF transaction IDs (e.g., obtained from relevant server(s) that may be in close proximity to a relevant EAS service area).

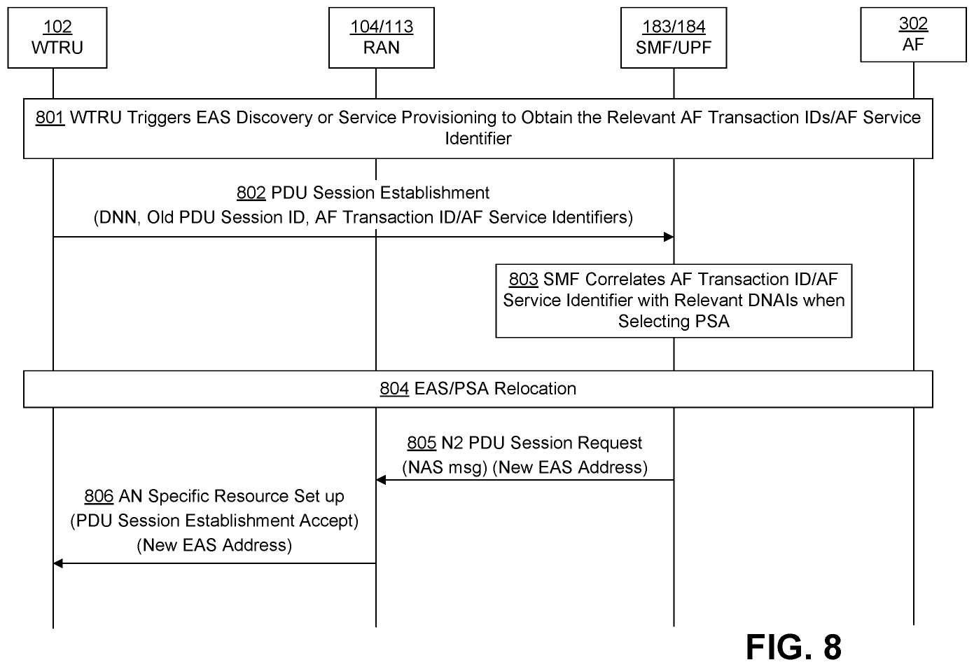

System level enhancements may be provided. Re-allocation of PSA and/or EAS may be proactive, for example, instead of reactive. As previously indicated, a WTRU 102 may obtain information (e.g., as shown in FIGS. 6 and 7), such as location information (e.g., DNN, TA/Cell ID and/or global positioning system (GPS) coordinates), for example, where an EAS 210 that provides user requested services is available (e.g., including service availability in EAS service areas for specified EAS IDs). A WTRU 102 may determine (e.g., based on the obtained information), for example, whether a new PDU Session should be established or whether an existing PDU session can be modified to obtain communications through a PSA 204 that provides (e.g., optimal) connectivity to a relevant EAS 210. An example procedure is described in FIG. 8.

FIG. 8 is a diagram illustrating an example of a combined application level and system level PSA relocation procedure. As shown in FIG. 8, at 801, a WTRU 102 may execute, for example, (i) a service provisioning procedure, (e.g., immediately) after the establishment of a first PDU session enabling data connectivity, for example, to a default ECS 524, or (ii) a service discovery procedure, e.g., triggered upon detection of certain information (e.g., location information such as DNN, TA/Cell ID or PGS coordinate, and/or trigger information). These (e.g., two) procedures may enable a WTRU to obtain, for example, an AF transaction ID or an AF service identifier of any relevant EASs.

At 802, the WTRU 102 may determine that connectivity should be established towards a particular EAS, for example, based on the information obtain in 801 and/or based on information regarding a spatial update and availability of one or more services (e.g., a certain service) in a current location. The type of available service(s) in the current location may be used to select the EAS 210. The WTRU may provide information to the network, such as AF transaction IDs or AF service IDs, for example, in support of the WTRU obtaining connectivity with a server (e.g., an optimal server). The WTRU may (e.g., also) provide, for example, in the “Old PDU Session ID” the PDU Session ID of the PDU Session connected to the central DN. The combination of Old PDU Session ID and the AF Transaction ID may indicate to the SMF 183 that the procedure is different from a procedure where the Old PDU Session ID is provided as in Session and Service Continuity (SSC) Mode 3. At 803, the SMF 183 may correlate the AF transaction IDs and/or AF service IDs with associated DNAIs, for example, when selecting applicable PSAs. The SMF 183 may elect/choose to use the Old PDU Session ID as a fallback connection, for example, if the WTRU 102 moves out of the service area of the local network. At step 804, the SMF may execute an EAS relocation and/or a PSA relocation (e.g., as described herein or elsewhere). For example, the EAS 210 or PSA 204 relocation (e.g., reallocation) may be performed as described herein. As another example, the EAS 210 or PSA 204 relocation (e.g., reallocation) may be performed using other techniques as would be understood by those skilled in the art. At 805, the SMF 183 may provide (e.g., to the RAN 104/113) the EAS address of an EAS 210 corresponding to the AF transaction IDs (e.g., in the N2 message that may carry the NAS session management message). At 806, the RAN 104/113 may provide the EAS address of an EAS corresponding to the AF transaction IDs to the WTRU, for example, via an RRC message containing the NAS session management message. For example, the AF transaction IDs may correspond to multiple EASs 210. At 805 and/or or 806, the addresses of the EASs 210 which correspond to the AF IDs may be provided by the SMF 183 as a list or similar information.

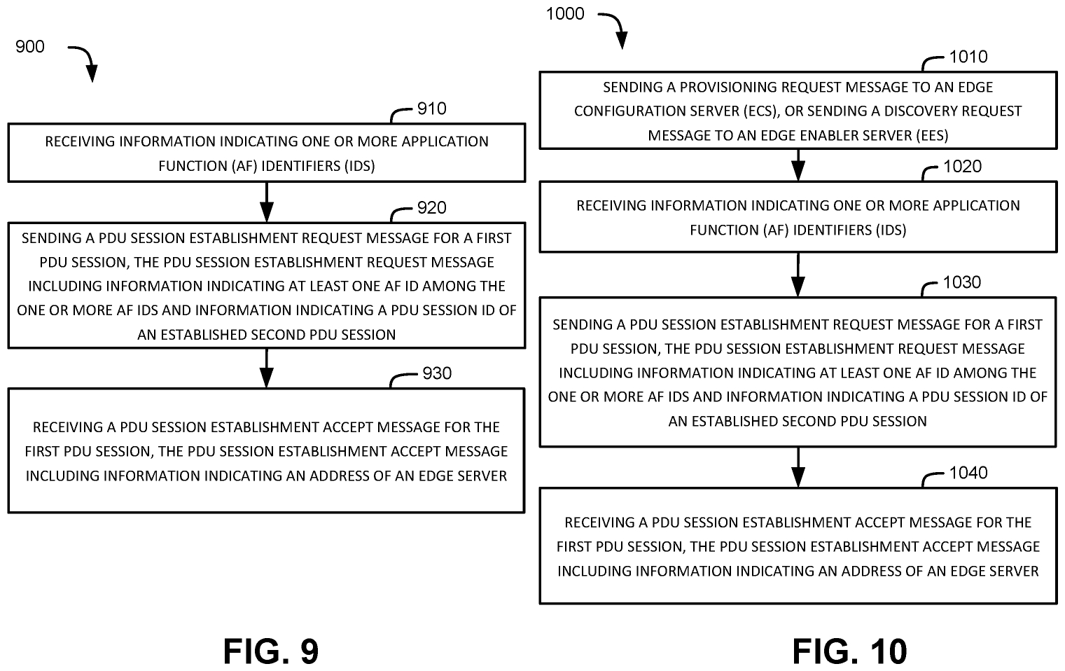

FIG. 9 is a diagram illustrating a representative example of a PDU session establishment procedure 900. As shown in FIG. 9, the PDU session establishment procedure 900 may begin with a WTRU 102 (e.g., application client 502) receiving information indicating one or more AF IDs at 910. For example, the AF IDs may include any of AF service IDs and/or AF transaction IDs. In certain representative embodiments, the one or more AF IDs may be received along with Information indicating any of DNN(s), URI(s), a Cell/TA list, PLMN ID(s) and/or local DN service area(s), such as if the DNN is a LADN. At 920, the WTRU 102 may perform sending (e.g., to a SMF 183 and/or UPF 184) of a PDU session establishment request message for a first PDU session (e.g., to be established). The PDU session establishment request message may include information indicating at least one AF ID among the one or more AF IDs (e.g., received at 910). The PDU session establishment message may include information indicating a PDU session ID of a (e.g., previously) established second PDU session. At 930, the WTRU 102 may receive a PDU session establishment accept message for the first PDU session. The PDU session establishment accept message may include information indicating an address of an edge server. For example (e.g., on condition multiple AF IDs are indicated at 1220), the PDU session establishment accept message may include information (e.g., a list) indicating multiple addresses which correspond to multiple edge servers (e.g., of an edge data network 520 which support an AF associated with the AF ID indicated by the PDU session establishment request message). In certain representative embodiments, the address of the edge server may be an EAS 210 or an EES 522.

FIG. 10 is a diagram illustrating another representative example of a PDU session establishment procedure 1000. As shown in FIG. 10, the PDU session establishment procedure 1000 may begin with a WTRU 102 (e.g., application client 502) sending, at 1010, a provisioning request message 601 (e.g., to an ECS 524) or sending an edge application discovery request message 702 (e.g., to an EES 522), for example as described herein. At 1020, the WTRU 102 may perform receiving of information indicating one or more AF IDs. The WTRU 102 may perform 1020 as part of the reception of a provisioning response 602 and/or the reception of an edge application discovery response 705 as described herein. For example, the AF IDs may include any of AF service IDs and/or AF transaction IDs. In certain representative embodiments, the one or more AF IDs may be received along with Information indicating any of DNN(s), URI(s), a Cell/TA list, PLMN ID(s) and/or local DN service area(s), such as if the DNN is a LADN. At 1030, the WTRU 102 may perform sending (e.g., to a SMF 183 and/or UPF 184) of a PDU session establishment request message for a first PDU session (e.g., to be established). The PDU session establishment request message may include information indicating at least one AF ID among the one or more AF IDs (e.g., received at 1020). The PDU session establishment message may include information indicating a PDU session ID of a (e.g., previously) established second PDU session. At 1040, the WTRU 102 may receive a PDU session establishment accept message for the first PDU session. The PDU session establishment accept message may include information indicating an address of an edge server. For example (e.g., on condition multiple AF IDs are indicated at 1220), the PDU session establishment accept message may include information (e.g., a list) indicating multiple addresses which correspond to multiple edge servers (e.g., of an edge data network 520 which support an AF associated with the AF ID indicated by the PDU session establishment request message). In certain representative embodiments, the address of the edge server may be an EAS 210 or an EES 522.

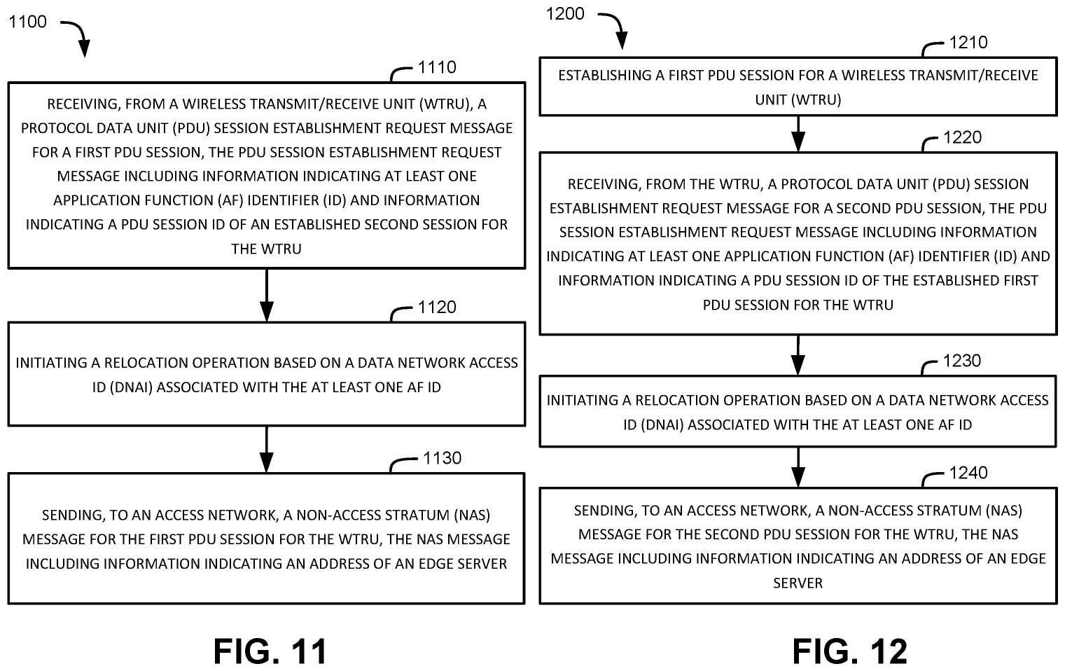

FIG. 11 is a diagram illustrating another representative example of a PDU session establishment procedure 1100. As shown in FIG. 11, the PDU session establishment procedure 1100 may begin with a network entity (NE) (e.g., SMF 183 and/or UPF 184) receiving (e.g., from a WTRU 102) a PDU session establishment request message for a first PDU session (e.g., to be established) at 1110. The PDU session establishment request message may include information indicating at least one AF ID. For example, the AF IDs may include any of AF service IDs and/or AF transaction IDs. The PDU session establishment request message may include information indicating a PDU session ID of an established (e.g., previously established) second PDU session. At 1120, the NE may initiate a relocation operation based on a data network access ID (DNAI) associated with the at least one AF ID (e.g., received at 1110). In certain representative embodiments, the relocation operation may include relocating (e.g., reallocating) a PDU session anchor (PSA) (e.g., to be associated with a data network corresponding to the DNAI) for an edge server (e.g., corresponding to the at least one AF ID). In certain representative embodiments, the relocation operation may include relocating (e.g., to or within a data network corresponding to the DNAI) an edge server (e.g., corresponding to the at least one AF ID), for example an EAS. At 1130, the NE may perform sending (e.g., to an access network serving the WTRU 102) of a non-access stratum (NAS) message for the first PDU session for the WTRU 102 (e.g., corresponding to the PDU session established by 1110). The NAS message may include information indicating an address of an edge server. For example (e.g., on condition multiple AF IDs are indicated at 1220), the NAS message may include information (e.g., a list) indicating multiple addresses which correspond to multiple edge servers (e.g., of an edge data network 520 which support an AF associated with the AF ID indicated by the PDU session establishment request message). In certain representative embodiments, the address of the edge server may be an EAS 210 or an EES 522.

FIG. 12 is a diagram illustrating another representative example of a PDU session establishment procedure 1200. As shown in FIG. 12, the PDU session establishment procedure 1200 may begin with a network entity (NE) (e.g., SMF 183 and/or UPF 184) establishing a first PDU session for a WTRU 102 at 1210. At 1220, the NE may receive (e.g., from a WTRU 102) a PDU session establishment request message for a second PDU session (e.g., to be established). The PDU session establishment request message may include information indicating at least one AF ID. For example, the AF IDs may include any of AF service IDs and/or AF transaction IDs. The PDU session establishment request message may include information indicating a PDU session ID of the established (e.g., previously established) first PDU session. At 1230, the NE may initiate a relocation operation based on a data network access ID (DNAI) associated with the at least one AF ID (e.g., received at 1220). In certain representative embodiments, the relocation operation may include relocating (e.g., reallocating) a PDU session anchor (PSA) (e.g., to be associated with a data network corresponding to the DNAI) for an edge server (e.g., corresponding to the at least one AF ID). In certain representative embodiments, the relocation operation may include relocating (e.g., to a data network corresponding to the DNAI) an edge server (e.g., corresponding to the at least one AF ID), for example an EAS. At 1240, the NE may perform sending (e.g., to or within an access network serving the WTRU 102) of a non-access stratum (NAS) message for the first PDU session for the WTRU 102 (e.g., corresponding to the PDU session established by 1220). The NAS message may include information indicating an address of an edge server. For example (e.g., on condition multiple AF IDs are indicated at 1220), the NAS message may include information (e.g., a list) indicating multiple addresses which correspond to multiple edge servers (e.g., of an edge data network 520 which support an AF associated with the AF ID indicated by the PDU session establishment request message). In certain representative embodiments, the address of the edge server may be an EAS 210 or an EES 522.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1.-52. (canceled)

53. A wireless transmit/receive unit (WTRU) comprising:
a processor and a transceiver which are configured to:
receive information indicating one or more application function (AF) identifiers (IDs);
send a protocol data unit (PDU) session establishment request message for a first PDU session, the PDU session establishment request message including information indicating: (1) an AF ID among the one or more AF IDs and (2) information indicating a PDU session ID of an established second PDU session; and
receive a PDU session establishment accept message for the first PDU session, the PDU session establishment accept message including information indicating an address of a first edge server associated with the AF ID.

54. The WTRU of claim 53, wherein the processor and the transceiver are configured to:
prior to receiving the information indicating the one or more AF IDs, send a request message to a second edge server, and receiving a response message from the second edge server,
wherein the response message includes the information indicating the one or more AF IDs.

55. The WTRU of claim 54, wherein the response message includes information indicating any of a data network name (DNN), a uniform resource ID (URI), a cell area ID, a tracking area ID, a public land mobile network ID, a local data network service area, and/or geographic information which are associated with the one or more AF IDs, and/or the request message includes information indicating a generic public subscription identifier (GPSI) associated with the WTRU.

56. The WTRU of claim 53, wherein the AF ID is a transaction ID and/or a service ID, and/or the PDU session establishment request message includes information indicating a data network name (DNN) associated with the AF ID.

57. The WTRU of claim 53, wherein the processor and the transceiver are configured to:
prior to receiving the information indicating the one or more AF IDs, send a PDU session establishment request message for the second PDU session.

58. The WTRU of claim 53, wherein the first edge server is any of an edge application server (EAS), and/or an edge enabler server (EES).

59. A method implemented by a network entity (NE), the method comprising:
receiving, from a wireless transmit/receive unit (WTRU), a protocol data unit (PDU) session establishment request message for a first PDU session, the PDU session establishment request message including information indicating: (1) an application function (AF) identifier (ID) and (2) information indicating a PDU session ID of an established second PDU session for the WTRU;
initiating a relocation operation based on a data network access ID (DNAI) associated with the AF ID; and
sending, to an access network, a non-access stratum (NAS) message for the second PDU session for the WTRU, the NAS message including information indicating an address of an edge server associated with the AF ID.

60. The method of claim 59, wherein the relocation operation includes any of relocating a PDU session anchor (PSA) for the edge server, and/or relocating the edge server to a data network corresponding to the DNAI associated with the AF ID.

61. The method of claim 59, wherein the NE includes a session management function (SMF), and/or the NAS message is a PDU session request message sent to an access network for the WTRU.

62. The method of claim 59 further comprising:
prior to receiving the PDU session establishment request message for the first PDU session, establishing the second PDU session for the WTRU.

63. The method of claim 59, wherein the AF ID is a transaction ID and/or a service ID, and/or the PDU session establishment request message includes information indicating a data network name (DNN) associated with the at least one AF ID.

64. The method of claim 59, wherein the edge server is any of an edge application server (EAS), and/or an edge enabler server (EES).

65. A network entity (NE), the NE comprising:
a processor and a transceiver configured to:
receive, from a wireless transmit/receive unit (WTRU), a protocol data unit (PDU) session establishment request message for a first PDU session, the PDU session establishment request message including information indicating: (1) an application function (AF) identifier (ID) and (2) information indicating a PDU session ID of an established second PDU session for the WTRU;
initiate a relocation operation based on a data network access ID (DNAI) associated with the AF ID; and
send, to an access network, a non-access stratum (NAS) message for the first PDU session for the WTRU, the NAS message including information indicating an address of an edge server associated with the AF ID.

66. The NE of claim 65, wherein the relocation operation includes to relocate a PDU session anchor (PSA) for the edge server, and/or to relocate the edge server to a data network corresponding to the DNAI associated with the AF ID.

67. The NE of claim 65, the NAS message is a PDU session request message sent to an access network for the WTRU.

68. The NE of claim 65, wherein the processor and the transceiver are configured to:
prior to receiving the PDU session establishment request message for the first PDU session, establish the second PDU session for the WTRU.

69. The NE of claim 65, wherein the PDU session establishment request message includes information indicating a data network name (DNN) associated with the at least one AF ID.

70. The NE of claim 65, wherein the AF ID includes an AF transaction ID and/or an AF service ID.

71. The NE of claim 65, wherein the NE includes a session management function (SMF).

72. The NE of claim 65, wherein the edge server is an edge application server (EAS) and/or an edge enabler server (EES).
